(19) United States
(12) Patent Application Publication
(10) Pub. No.: US 2006/0117091 A1
(43) Pub. Date: Jun. 1, 2006

(54) Data logging to a database

(76) Inventor: Antony Manoj Justin, Spring, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/000,019

(22) Filed: Nov. 30, 2004

(51) Int. Cl. G06F 15/16

(52) U.S. Cl. 709/217; 709/223

(57) ABSTRACT

Logging data to a database involves gathering log data from one or more applications executing on a first data-processing arrangement. The log data is gathered via a data-gathering utility executing on a first data-processing arrangement. The log data is sent via a network to a Web services interface of a log server. The log data is stored in a database accessible by the log server. The status of the first data processing arrangement is determined based on the log data stored in the database.

### FIELD OF THE INVENTION

The present disclosure relates to data processing, and more particularly to handling log data of data processing arrangements.

### BACKGROUND

Computers and networks have become commonplace in all types of enterprises, including manufacturing, services, government, and academia. Computers play important roles in these organizations. In particular, the use of computing networking has provided significant productivity gains over the last decade. In many cases, the networks have become as important as the computers themselves. Computer networks can be used by all parts of an organization to quickly and easily share data. Data sharing allows managers to know what is going on within the organization and to quickly react to problems and changes.

Networks can range in size from two machines on a home network to global scale networks such as the Internet. The smaller networks are often referred to as local area networks (LANs). A LAN can be used to share computing resources such as files and printers. In some arrangements, common computing resources are shared in a client/server arrangement. The clients are typically stand-alone computers that access a server. The servers are centralized computers that provide particular services to clients. Other paradigms for computer usage exist, such as peer-to-peer, terminal/server and thin-client/server. However, the implementation of Internet-like services in enterprises has made the client/server model dominant in many business infrastructures.

In a large enterprise, the services provided by servers and other entities may be quite complex. Besides the standard email, file sharing, print sharing and Web services associated with the client-server model, large enterprises may have custom applications. These applications can be used for Customer Relationship Management (CRM), human resources, engineering, inventory, materials acquisition, finance, etc. These applications often leverage the power of networks by utilizing distributed computing, network accessible databases, Web services, and other network technologies to perform specialized functions.

Deploying and maintaining specialized applications in a large enterprise can be difficult. Such applications can have many users distributed around the globe. Even when all the users are in the same building, the analysis of performance data and error logs sometimes requires physically accessing the client machines to look at the data. This quickly becomes unworkable when maintaining a large number of machines. Therefore a better way of managing log data in a distributed computing environment is desirable.

### SUMMARY

Logging data to a database involves gathering log data from one or more applications executing on a first data-processing arrangement. The log data is gathered via a data-gathering utility executing on a first data-processing arrangement. The log data is sent via a network to a Web services interface of a log server. The log data is stored in a database accessible by the log server. The status of the first data processing arrangement is determined based on the log data stored in the database.

### BRIEF DESCRIPTION OF THE DRAWINGS

FIG. 1 illustrates a system in which data logging according to embodiments of the present invention may be employed;

FIG. 2 illustrates a data processing arrangement with a data-gathering utility according to embodiments of the present invention;

FIG. 3 illustrates logging data associated with distributed transactions according to embodiments of the present invention;

FIG. 4 illustrates a component diagram of a data-gathering utility according to embodiments of the present invention;

FIG. 5 illustrates a logging database server arrangement according to embodiments of the present invention;

FIG. 6 illustrates a sequence of data exchanges in a logging system according to embodiments of the present invention;

FIG. 7 is a flowchart illustrating client logging operations according to embodiments of the present invention; and

FIG. 8 is a flowchart illustrating server logging operations according to embodiments of the present invention.

### DETAILED DESCRIPTION

In the following description of various embodiments, reference is made to the accompanying drawings that form a part hereof, and in which is shown by way of illustration various example manners by which the invention may be practiced. It is to be understood that other embodiments may be utilized, as structural and operational changes may be made without departing from the scope of the present invention.

In general, the present disclosure relates to collecting, collating and providing analysis tools for computer debug data. In particular, a system is disclosed for centrally collecting log data in a distributed computing environment. A distributed computing environment generally includes at least a plurality of client machines independently running processes that generate logging data. The client machines may communicate with one or more server machines via a network. The client machines may also communicate with each other, either as client-server or peer-to-peer.

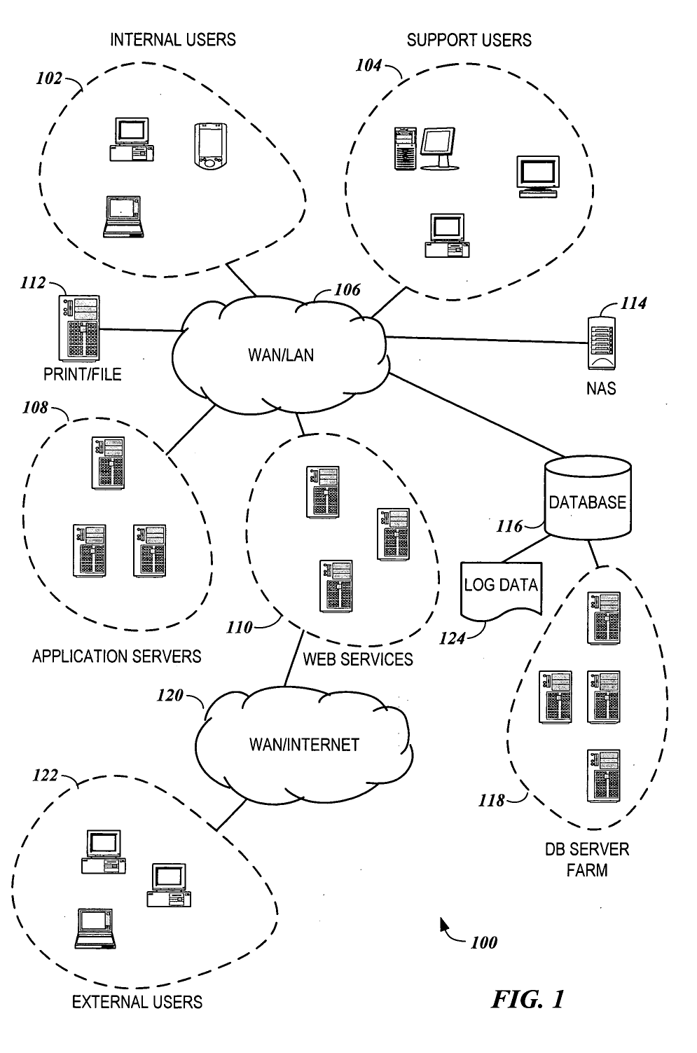

In reference now to FIG. 1, a system 100 is illustrated that utilizes centralized logging according to embodiments of the present invention. The system 100 is generally utilized by an enterprise for all manner of computing tasks. The system 100 includes internal user computers 102 and support user computers 104. The user computers 102, 104 are typically networked client machines, although some users 102, 104 may also have access to servers via directly connected terminals or similar devices. The user computers 102, 104 may include any manner of data processing device, including desktops machine, portable computers, personal digital assistants (PDAs), cellular phones, etc.

The internal user computers 102 typically run end-user applications. These applications often have a user interface (UI) configured to allow people to input data into the computer and receive output. For example, a human resource time tracking system allows workers to enter hours worked for different projects using a keyboard and mouse. The time and project data entered may be viewable by the user and others. The internal user computers 102 may be used for any type of end-user application, including finance, human resources, engineering, marketing, sales, inventory, materials tracking, content creation, data entry, etc.

The support user computers 104 may run applications that are similar to those run on the internal user computers 102. However, the support user computers 104 may also include support applications. The support applications may include network monitoring tools, help ticket reporting, technical support databases, debuggers, remote access applications (e.g., login terminals), etc.

The user and support computers 102, 104 are coupled via a network 106. This network 106 may include any combination of LAN and Wide Area Network (WAN) elements known in the art. The user and support computers 102, 104 may exchange data directly (e.g., peer-to-peer) via the network 106. The computers 102, 104 may also use the network 106 to access servers, such as the application servers 108, Web services servers 110, print/file servers 112, Network Attached Storage (NAS) 114, etc. In general, servers may include any commonly accessible data processing elements that store and manage data. The data may be restricted to select users or may be made available to all users of the system 100.

A database 116 may also be commonly accessible to clients and servers on the network 106. The database 116 is typically a specialized data storage arrangement for storing and querying large amounts of data quickly. The database 116 often stores data in the form of tables. In a particular type of database known as a relational database, associations may be defined between the tables that allow sophisticated and flexible searching of data. The database 116 may be implemented on a single machine. In other arrangement, the database 116 may be distributed across multiple machines, such as on a server farm 118. Often, the database 116 includes a generic interface that hides the programmatic and physical implementation of the database 116 from users. For example, the database may support standardized Structured Query Language (SQL) queries.

The system 100 can provide many advantages to an organization. Tasks that require data inputs from various parts of the organization can be entered into computer systems (e.g., internal user computers 102) and stored on commonly accessible servers. By doing this, the managers of the organization can obtain near-real-time data that shows status of many activities in the organization. These activities need not be confined to a single building or campus. The ubiquity of wide area networks such as the Internet 120 allow this data exchange to occur on national and global scales. In sophisticated enterprise systems, external users 122 can seamlessly connect to the organization wherever there is Internet 120 availability.

Regardless of the advantages, distributing tasks among users of the system 100 can give rise to problems. These problems often relate to tracking technical problems on transactions that occur between distributed computational resources of the system 100. For example, a transaction may involve computations that occur on both internal user computers 102 and Web services servers 110. If the internal user computers 102 are using standalone PCs, the log data is typically stored on the local machine in a file or database. Likewise, the log data of the Web services servers 110 will be stored locally on those servers 110. It can be difficult to match up log data for a single transaction that occurred partially on a user computer 102 and a server 110. This may be exacerbated when the different computers use different operating systems and different methods of creating and storing log data.

In order to better manage log data among elements of the system 100, a database 116 may be set up as a centralized repository of log data 124. Computing elements of the system may generate, modify and send log data 124 to this commonly accessible database 116. Elements that generate log data may include internal users 102, support users 104, external users 122, servers 108, 110, 112, 114, etc. The log data may originate from an application, process, daemon, service, module, operating system, or any other executable code running on any device in the system 100.

It will be appreciated that a wide variety of software running on different hardware and operating systems will incorporate a wide variety of logging techniques. These logging techniques may include sending logs to files, memory, network connections, OS messaging, Inter-Process Communications (IPC), and the like. Therefore, a logging system that is useful across the entire enterprise should be able to take these various logging methods into account.

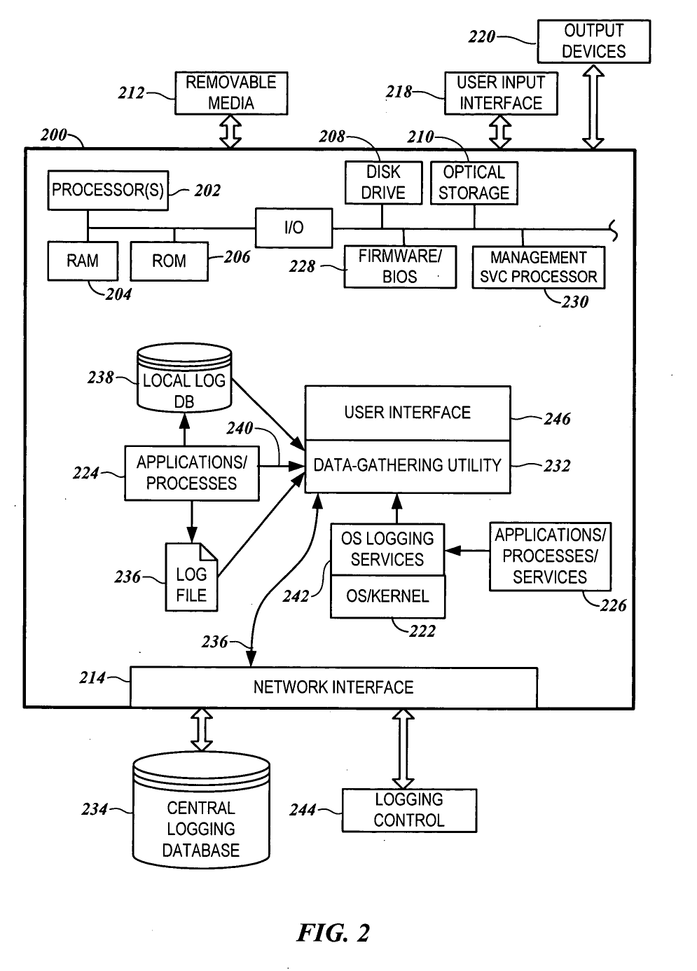

Referring now to FIG. 2, a data processing arrangement 200 is shown using a logging utility according to embodiments of the present invention. The data processing arrangement 200 may be representative of any computational device used in the enterprise, including desktop computers, servers, portables, PDAs, embedded devices, etc. The data processing arrangement 200 includes one or more processors 202 coupled to various forms of memory. The processor(s) 202 are arranged to execute instructions stored on or provided by such memory. Memory accessible by the processor(s) may include random access memory (RAM) 204, read-only memory (ROM) 206, disk drives 208, optical storage 210 (e.g., CD-ROM, DVD), etc. The processor(s) 202 may also access data via memory available on removable media 212, such as floppy disks, Zip disks, flash memory, CD-ROM/R/RW, DVD, etc. The processor(s) 202 may also execute instructions received via a network interface 214. The network interface 214 may be data coupled to any data transfer network such as a LAN, WAN or global area network (GAN) such as the Internet.

The data processing arrangement 200 may include and/or be coupled to a user input interface 218 and an output device 220 (e.g., a monitor) for interacting with users. The data processing arrangement 200 includes software that may be provided in the form of instructions executable by the processor(s) 202. Generally, the software includes an operating system (OS) 222 for the control and management of hardware and basic system operations, as well as running processes/applications 224, 226. The OS 222 may include any type of kernel (e.g., monolithic kernel, microkernel, exokernel, etc.) and user interface software such as a shell and/or graphical user interface (GUI).

The data processing arrangement 200 includes firmware 228 used by the OS/kernel 222 for accessing hardware and processor functionality during boot time and run time. The firmware 228 may include a Basic Input-Output System (BIOS) for providing basic hardware access during system boot. The data processing arrangement 200 may also include independently running hardware/processors such as a management service processor 230. A management service processor 230 may be utilized in server farms, clusters, and other remotely serviced and managed systems. The management service processor 230 runs independently of the processor(s) 202 and OS 222 of the data processing arrangement 200. The service processor 230 may be remotely accessed for checking status, logs, and providing system updates, including revisions to firmware/BIOS 228.

It will be appreciated that the example data processing arrangement 200 need not contain all of the software and hardware components listed for purposes of performing centralized logging. However, the arrangement 200 may at least include a data-gathering utility 232 for receiving, formatting, and sending log data to a centralized logging database 234. The data-gathering utility 232 is typically configured as a locally running process that gathers logs and other useful maintenance data from various parts of the data processing arrangement 200.

The data-gathering utility 232 may collect logging data from any source on the data processing arrangement 200. Those sources may include applications, processes, services, operating systems, firmware, hardware, etc. For example, the data-gathering utility 232 may collect data from user applications 224. This data collection may occur by examining local log files 236 or other persistent storage such as a local database 238. The data-gathering utility 232 may collect data from these persistent sources 236, 238 by any mechanism known in the art, including polling, redirection of output, monitoring write accesses, etc.

The data-gathering utility 232 may also collect log data from the application 224 directly, as represented by path 240. This direct collection may be accomplished through mechanism such as pipes, messages, IPC, and the like. The OS 222 may also provide a standardized way for applications/process/services 226 to report logging data. This is represented by the logging services module 242. The logging services module 242 may be accessed via a standard Application Program Interface (API) provided for use with the OS 222. The data-gathering utility 232 may also access this API to receive log data from the logging services module 242.

Another function of the data-gathering utility 232 is to send data to the central logging database 234. The database 234 may be accessed via a network as indicated by path 236 to the network interface 236. Other data interfaces may also be used to send log data to the database 234. For example, data busses such as serial, USB, IEEE 1394, direct wireless transmissions, and the like, may be used to communicate log data to the database 234.

In addition to sending data, the data-gathering utility 232 may also receive data via the network interface 236 and other external data interfaces. For example, a logging controller 244 may be used to externally control aspects of the data-gathering utility 232. The logging controller 244 may control behavior of the logging application 232 such as debug log levels, enabling logging, system parameters, security settings, etc. The behaviors of the data-gathering utility 232 may also be controlled locally via a user interface (UI) 246. In addition, the user interface 246 may control other local settings such as user identity, transformation/filtering of logs, UI preferences, performance settings, etc.

The data-gathering utility 232 may be utilized on any computing arrangement that generates log data. The data-gathering utility 232 may be configured and compiled for particular computers and operating systems. This OS-specific code may include both binary code (e.g., compiled C/C++ code) and interpreted code (e.g., Visual Basic™). The data-gathering utility 232 may also utilize OS-independent code, such as a Java™ applications.

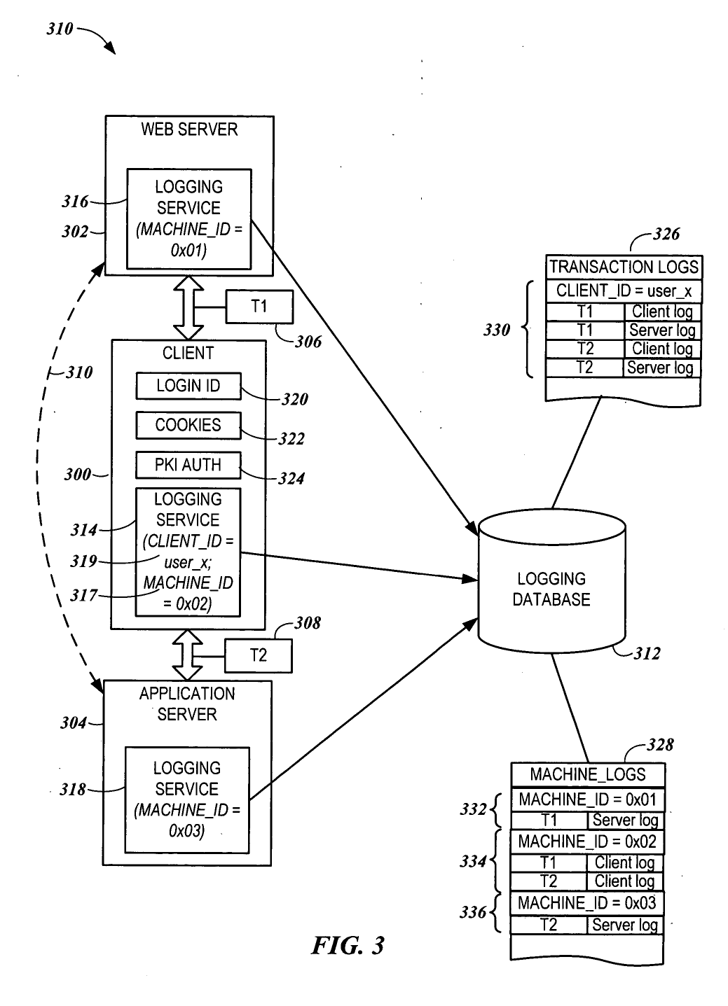

The data-gathering utility 232 generally includes a uniform interface for communicating with the database 234. The uniform logging interface provides the ability to collect a uniform set of logs from multiple hosts without requiring details of the underlying database architecture. This uniformity of log data is useful when disparate hosts each create logs that relate to a single transaction. An example of a multi-host transaction according to embodiments of the present invention is shown in FIG. 3. Three network elements are shown in FIG. 3: a client 300, a Web server 302, and an application server 304.

The client 300 is often the initiator of transactions, such as in response to user actions/inputs. Network transactions may result from these inputs, and the transactions may involve communications between a number of computing elements. In the illustrated example, two transactions 306, 308 are illustrated. Transaction 306 involves the client 300 accessing the Web server 302. This transaction 306 may occur, for example, in response to a Hypertext Transfer Protocol (HTTP) “GET” method call. The other transaction 308 is between the client 300 and the application server 304. This transaction 308 may be, for example, a Remote Procedure Call (RPC).

Real world transactions may involve many lines of debug logging and involve more than two machines. For example, the Web server 302 may invoke an RPC call on the application server 304 in response to a request, as represented by path 310. In such scenarios, it is useful to gather all of the log data in a commonly accessible database 312.

It will be appreciated that for the illustrated transactions 306, 308, log data will be generated at both the client 300 and the servers 302, 304. For this simple example, it will be assumed that the transactions 306, 308 generate one line of debug at the client 300 and the affected server 302, 304. The actual log data is represented in FIG. 3 by the text “Server log” or “Client log” as appropriate.

To gather the log data into the database 312, the client 300, Web server 302, and application server 304 each include data-gathering utilities 314, 316, and 318, respectively. Each of the data-gathering utilities 314, 316, and 318 maintain internal variables that are of use when entering data into the database. For example, a machine ID (e.g., ID 317) is useful to identify the physical device that generated the log. The machine ID may be, for example, an Internet Protocol (IP) address, a processor ID, a Media Access Control (MAC) address, etc. In the illustrated example, the machine ID 317 is a hexadecimal value. The client data-gathering utility 314 also maintains a client ID 319, which is set to “user_” in this example. The client ID 319 is useful for tracking transactions initiated by the user of a client computer 300.

The client ID 319 may include any user specific data that is appropriate for the target application. The client ID 319 may be formed using a login/email ID 320, a value stored in a browser “cookie” 322, an encryption key 324, or any other data token known in the art. The machine ID 317 may also be used as a part of a client ID 319.

The data-gathering utilities 314, 316, and 318 may include: identifying data along with the log data so that the log data can be identified and categorized in the database 312. In the illustrated database 312, the log data is shown into two tables, a transaction log table 326 and a machine log table 328. The transaction log table 326 is indexed by client ID, and contains entries 330 for both of the illustrated transactions 306, 308. The machine log table 328 contains entries 332, 334, 336 indexed by machine ID. It will be appreciated that for purposes of keeping the database 312 compact, all the log entries would likely be placed in a single log table. The data from this single log table can be queried to produce the listings shown in the transaction log table 326 and a machine log table 328.

The database 312 may contain other tables useful for analyzing debug log tables. For example, tables may be created that describe users and machines to help link logs that were generated from different computers involved in distributed transactions. In some computers, certain identity information may not be included the logging data. Some servers, for example, may not have access to the user ID 319 of the transaction initiator. However, data such as IP address of the source (e.g., the client 300) may be included in these server logs. In that case, user and machine tables in the database 312 may be used to link a source IP address to a particular user ID.

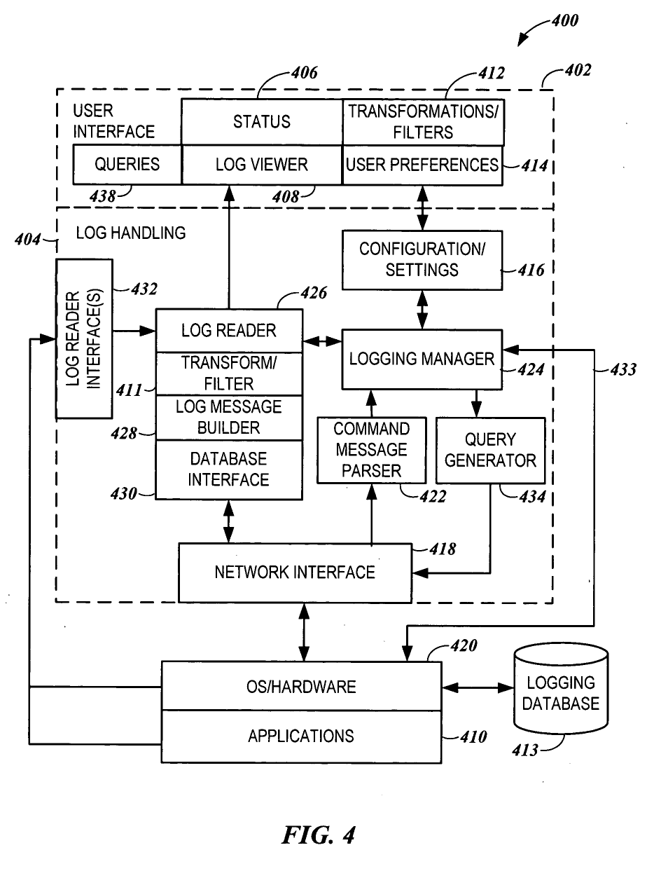

As shown in FIG. 3, various data-gathering utilities 314, 316, 318 are utilized to collect log data and send that data to the database 312. The data-gathering utilities 314, 316, 318 may include any form of binary instructions, interpreted code, scripts, hardware, and firmware. The components of an example data-gathering utility 400 according to embodiments of the present invention are shown in FIG. 4. The data-gathering utility 400 is divided into two functional components, a user interface 402 and a log handler 404. The log handler 404 may be configured to gather, modify, and send logging data. The user interface 402 allows a user to configure and control the behavior of the utility 400, as well as to view data used by the utility 400, including the logs themselves.

The user interface 402 may include a status component 406 that provides the user with status data. The status data may include indications as to whether the application 400 is currently operating, number of logs collected/sent, existence of errors, etc. The user interface 402 may also include a log viewer component 408 that provides the user with a real-time or historical playback of logging data. The viewer component 408 may present, for example, a list of log messages along with associated meta-data such as time stamps, originating application, etc.

Many times, the log messages are in a format that is specified by a particular application 410. If the application 410 is written by a third party, the data-gathering utility 400 may have no control over the format of those logs as they are received. Therefore, the data-gathering utility 400 may include a transformation component 411 that transforms and formats log messages. The transformations may be defined by a transformation/filter component 412 of the user interface 402.

Transformations applied by the transformation component 411 may make the logs easier to read and/or make the messages more compliant with what is expected for use in a logging database 413. For example, the application 410 may include text or binary numerical codes as part of debug output. The numerical codes may map to one or more error strings. The transformation component 411 may be configured to parse those numerical values, look up the error strings, and replace the numerical values with the strings. The transformation component 411 may also be used to transform cryptic or misleading text messages. For example, the transformer 411 may be configured to automatically change the text “ERROR ON DISC LOAD DRIVE” to “CD ROM DRIVE NOT WORKING.”

The transformation component 411 may also be used to filter logging data. For example, for some situations, the user may want to report only the error messages of the application 410, and ignore status messages. If the application 410 cannot limit the debug output in this way, the transformation component 411 may be configured to detect and discard all non-error messages. The transformation component 411 may perform this function by string searching using regular expressions or other search methods known in the art.

The transformer component 411 may get its transform and filter settings from any combination of a local source (e.g., the transform/filter component 412 and/or a configuration file) and a remote source (e.g., the logging database 413). The user may manage other application settings via a user preferences component 414 of the user interface 402. The user preferences component 414 may be used to set any other preferences of the user interface 402 and the log handler 404. These preferences may include GUI settings, applications selected for log reporting, performance parameters (e.g., use of compression, binary messages), destination databases, authentication, security, network parameters, etc.

The user preferences component 414 provides a user accessible front end to manage configuration settings. The storage and retrieval of those settings is handled by a configuration/settings component 416 of the log handler 404. The configuration/settings component 416 interfaces with persistent storage (e.g., registry, configuration file) to maintain settings between sessions. The configuration settings component 416 may also utilize a network interface 418 for retrieving remotely stored settings and/or receiving dynamic commands via a network control entity. For example, the user settings may be accessed from a Web server using HTTP commands via the network interface 418, so that certain settings remain constant no matter what physical machine the user is on.

The network interface 418 in this example is a software interface designed to transparently access network hardware via the OS 420. The network interface 418 may provide a generic interface that allows network data access using multiple network protocols (e.g., HTTP, SOAP, RPC). The use of a generic network interface 418 allows the components of the application 400 to be designed independently of the underlying networking technologies used in the enterprise.

It will be appreciated that in many cases a system maintainer may want to remotely switch logging facilities on and off, or set a particular debug level to restrict the amount of data received at the logging database 413. This may be accomplished by sending command messages to the data-gathering utility 400 via a network. The data-gathering utility 400 may include a command message parser 422 to handle command messages received via the network interface 418. These messages can be interpreted at the parser 422 and be passed along to a logging manager 424. One function of the logging manager 424 is to handle control logic for the application 400.

The parser 422 may also be configured to deal with messages and alerts sent via a technical support service. The messages and alerts may be directed to a component of the user interface 402 (e.g., the status component 406) to alert the user to important information such as system malfunctions. Alerts received at the data-gathering utility 400 may contain data that assists the user in solving a particular problem. For example, the alerts may contain a hyperlink to an application server where the user may download a software component (e.g., patch or program) that solves the problem. Alternatively, the alert may contain executable code (e.g., script or binary instructions) that may be passed to the logging manager 424 for further handling. Typically, the logging manager 424 would pass this executable code to the OS 420 for execution/processing. The execution of such code would likely be predicated upon user acceptance and involve other checks, such as verifying authentication certificates and code integrity (e.g., MD5 digest). These checks may be performed by the OS 420 and/or the logging application manager 424.

The logging manager 424 generally handles the control logic for operation of the data-gathering utility 400. The logging manager 424 may be configured to receive commands from both the user via the user interface 402 and from remote sources via the network interface 418 and parser 422. These commands can be used to set states of the data-gathering utility 400. The states of the data-gathering utility 400 may include persistent states (e.g., logging turned on or off) that are maintained by the configuration settings component 416. Dynamic states (e.g., current activity level) of the data-gathering utility 400 may also be tracked by such components as the logging manager 424 and the user interface 402.

In addition to the previously discussed transformer/filter component 411, the log handler 404 may include other components for processing log data received from the application 410. These components include a log reader 426, a log message builder 428, a database interface 430, and log reader interface 432. The log reader interface 432 may include one or more specific interfaces used to receive logs generated by applications 410, the OS 420, and any other system component capable of generating logging data. The log reader interface 432 may contain multiple data interface instantiations to read from sources such as files, OS services, messages, IPC, etc.

The logging manager 424 may also be used to arbitrate the connections between the log reader interface 432 and the applications 410. For example, the logging manager 424 may be configured to automatically detect the addition and/or deletion of applications 410 from the system. This detection may occur, for example, by the use of specialized registry entries maintained by the OS 420. The log handler may check these registry entries on startup and/or by regular polling of the registry, as indicated by the path 433. If a new application 410 is detected, the logging manager 424 may configure the log reader interface 432 to receive data from this new application 410.

The logging manager 424 may also be configured to detect whether a previously detected application 410 is currently running. If the application 410 is not running, there is no need to activate a log reader interface 432 for that application 410. However, the logging manager 424 may use facilities available via the OS 420 to detect when the applications 410 start, and thereby activate an appropriate log reader interface 432 to collect logs from that application 410.

The log data received at the log reader interface 432 is passed to the log reader 426 that buffers and selects messages for further processing. The log reader 426 passes selected messages to the transformer/filter 411 that processes the messages as previously described. The transformer/filter 411 then passes the log data to the message builder 428, which may add system data to the logs (e.g., timestamps, IDs) and create a message conforming to a standard format. The message builder 428 passes the messages to the database interface 430, which handles the formats and states required to send the messages to the logging database 413.

The database interface 430 may also be configured to read log data from the logging database 413. For example, the user may desire to use the data-gathering utility 400 to query log data from this or other computers that is stored in the database 413. The application 400 may include a query generator 434 that sends inquiries to the logging database 413. The query responses may be received at the database interface 430 and sent to the log viewer 408, either directly or via the log reader 426. The query generator 434 may have an associated query UI component 438 to assist in forming the queries.

It will be appreciated that variations of the data-gathering utility 400 may be tailored to specific users. For example, for users outside the enterprise (e.g., external customers), the application 400 may be configured to track only a small set of actions, such as those actions required to access enterprise Web sites. This restricted operation may be preferable for reasons of limited bandwidth and privacy. For an external user, the logging information would be transferred from the application 400 to the logging database 413 using a secure method such as Secure Sockets Layer (SSL).

In another example, the data-gathering utility 400 may be tailored for use by support users (e.g., help desk clients). In such a configuration, the reading of local logs via the log reader interface 432 may not be required because the maintainer is generally interested in the logs of other machines. A maintainer would typically access stored log data through the query generator 434. The configuration of the data-gathering utility 400 used by the maintainer would likely have much broader permissions to access the database 413 and other computers than would a typical user configuration. A maintainer application may also include other components for controlling logs, such as a command generator and analysis tools.

The data-gathering utility 400 may also be adapted for users such as software developers. The utility could be use to transmit logs of debug output, compiler warnings/errors, etc., to the database 413 instead of writing this data locally. The data-gathering utility 400 may have custom designed interfaces 402 for various types of users from finance to technology which are configurable and log enabled. The data-gathering utility may also be enabled to transfer history or browsing usage from the Web browsers to the logging database 413. This way, all browsing history of a user will be in a central place through which an administrator can generate reports and make use of them.

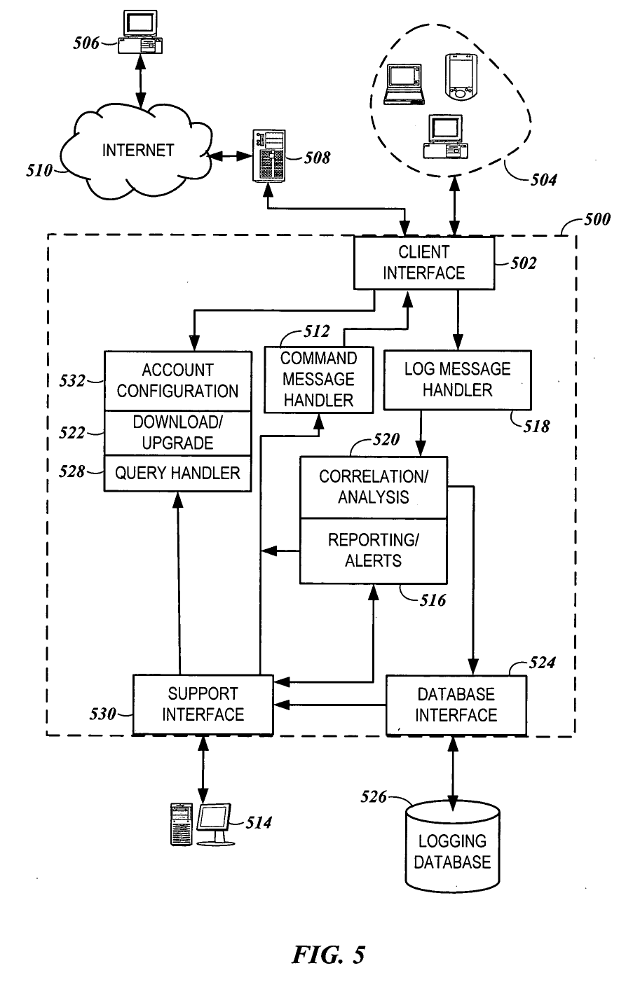

Generally, the log data collected by the data-gathering utility 400 is sent to a commonly accessible logging database 413. Such a database 413 may associated with a logging database server that provides system-wide monitoring and control of data logging activities. An example of a logging database server 500 according to embodiments of the present invention is shown in FIG. 5. The database server 500 may be included on a single machine or distributed among multiple physical machines.

The database server 500 contains a client interface 502 that receives log data from a plurality of internal clients 504. The client interface 502 may also receive log data from external clients 506, such as via a Web server 508 coupled to the Internet 510. The client interface 502 may also send data to internal clients 504 and external clients 506. For example, the client interface 502 may send configuration settings from a command message handler module 512 to clients 506, 508.

The command message handler 512 is used to route command messages to logging software on client computers 506, 508. The commands may originate from a support user machine 514 or be automatically generated via a reporting/alerts module 516 of the database server 500. The command message handler 512 may provide the ability to identify particular clients 506, 508 as targets for command messages. In other scenarios, the command message handler 512 may broadcast or multicast messages to groups of machines. The command message handler 512 may also handle other bookkeeping tasks involved in sending messages, including receiving acknowledgements and reporting failures or errors in the commands. It will be appreciated that the functionality included in the command message handler 512 may also be included entirely within the support user machine 514 and similar entities.

Client log data received at the client interface 502 may be sent to a log message handler 518. The log message handler 518 may perform actions such as buffering messages, checking log messages for errors, stripping headers from messages, etc. The log message handler 518 then passes messages to a correlation/analysis module 520. The correlation/analysis module 520 may be used for data reduction (e.g., grouping redundant data), correlating messages with transaction identifiers, monitoring rate of incoming messages, identifying patterns, etc. The analysis data gathered by the correlation/analysis module 520 may be used by the reporting/alerts module 516.

It will be appreciated that the correlation/analysis module 520 and reporting/alerts module 516 may be used to quickly identify and resolve system problems. For example, the reporting/alerts module 516 may be configured to detect a threshold number of logging errors that indicate a server is refusing connections. This may be used to generate an alert that is sent to a support user 514 for resolution. In another example, a recognizable pattern of logging errors may indicate that a system has misconfigured software (e.g., incompatible versions) or compromised software (e.g., infected with a virus). The correlation/analysis module 520 and reporting/alerts module 516 may be used to detect these patterns and alert a client machine (e.g., client 504) of the problem. The alert may also provide a solution for the user, such assisting in downloading a software patch via a download/upgrade module 522 of the server 500.

After passing through the correlation/analysis module 520, the logging messages are then sent to a database interface 524 for placement in a database 526. The database 526 may be a relational database (e.g., SQL compatible) such as Oracle, SQL Server, DB2, MYSQL, and the like. The database 526 may be XML-enabled, object-relational, object-oriented, multi-dimensional, and include any other features known in the art. The database 526 may be implemented on a single host or be distributed over multiple hosts.

Access to the database 526 may be provided to various clients (e.g., 504, 514) via a query handler 528. For example, the query handler 528 may receive a query from a support user 514 via a support interface 530. The query handler 528 may transform this query (e.g., from plain text to an SQL query) and send the query to the database interface 524. The response to the query may pass through the query handler 528 or be sent directly to the requesting user 514.

The database 526 may contain a wide variety of information pertaining to client users and equipment. This information may be used to form specialized queries of the database 526. For example, a query could be used to answer a question such as “How many seconds is boot up on a HP Pavilion with Pentium 4 2.4 GHZ processor running windows?” The query handler 528 could process this query through the database interface 524 and provide a response. Such query responses could present the average of all such systems, and also break down information by major component differences such as OS versions (Windows™ 3.1, 95, Millennium, XP, 2003, etc.), amount/type of memory, video drivers, software differences, etc. These specialized reports could be processed using Online Analytical Processing (OLAP) tools.

The database 526 and correlation/analysis module 520 could also be used for pattern analysis and recognition on stored data. For example, patterns of stored data could be analyzed to answer such performance optimization questions as “What is the difference between systems that boot in 30 seconds versus those that take longer?” or “What is the difference in the input error rate between a Wacom tablet and a Microsoft Natural Keyboard?” Similarly, the stored data could be analyzed to provide troubleshooting and problem resolutions. For example, user could compare system configuration with those in the database 526. If other users are located that had similar problems, the solution those other users used could be determined.

The database server 500 and related equipment can serve as a repository and analysis center for enterprise-wide logging data. The database server 500 may also provide other commonly accessible functions related to logging. For example, an account configuration module 532 may be accessed to read, save, and modify user account information. The account configuration module 532 may be useful in applying system wide configuration settings, such as setting default log levels.

The client interface 502, database interface 524, and support interface 530 may use any combinations of new and existing data transfer protocols. For example, the client and support interfaces 502, 524, may be Web services based. Web service interfaces may support, for example, Simple Object Access Protocol (SOAP) calls over HTTP. The database interface 524 may be native to the database 526, or may include middleware components that provide generic database access methods that are independent of a particular database 526.

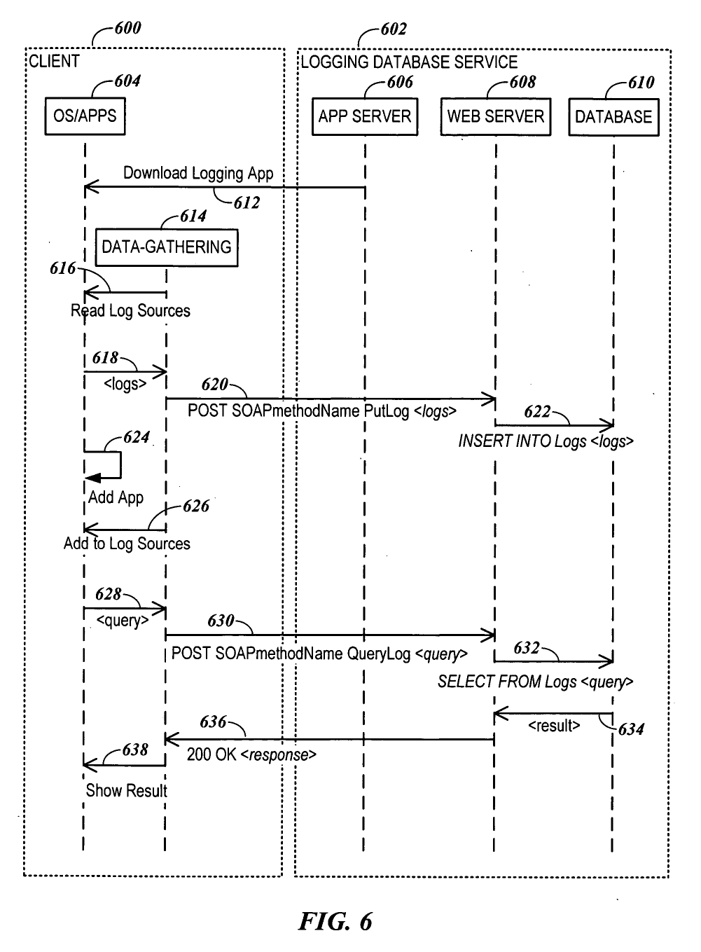

The functions of the database server 500 may be provided on a single computing arrangement or be distributed among various server components. An example of logging transactions that occur between multiple client and server components according the present invention is shown in FIG. 6. In FIG. 6, a sequence diagram shows transactions between a client 600 and a logging service 602. The client 600 at least includes an OS and applications 604. The logging service 602 includes an application server 606, a Web server 608 and a database 610. These logging service components 606, 608, 610 may be distributed across different physical machines or be hosted on a single machine.

Initially, the client 600 downloads (612) the data-gathering utility 614 from the application server 606. Once the data-gathering utility 614 is started, it will read (616) the available log sources from a system registry or other source on the client 600. Subsequently, the data-gathering utility 614 can receive logs (618) from the OS and application 604. These logs can be sent (620) by the data-gathering utility 614 to the Web server 608. In this example, the logs are sent (620) using a SOAP method invocation. The Web server 608 puts (622) the logs into the database 610, in this example via a SQL “INSERT INTO” command.

The data-gathering utility 614 may be configured to monitor the client system 600 for any software additions that are a source of additional logs. If software is added (624), the data-gathering utility 614 may add (626) this new software to the list of log sources. Subsequently, log data from this new application will be added to the database 610 as previously described (e.g., receiving 618, sending 620, and inserting 620).

In some cases, the client 600 may need to retrieve logs from the database 610. The data-gathering utility 614 may facilitate log retrieval by accepting a query (628) from the user via hardware coupled to the OS 604 (e.g., a keyboard and mouse). The query need not be limited to selecting logs from this particular client 600. For example, the query may be used to retrieve logs from a transaction that was distributed across many network entities. The query is sent (630) to the Web server 608 via a SOAP method. The SOAP method is used to form a SQL “SELECT FROM” for selecting (632) the desired logging data. The result is sent (634) to the Web server 608, which formats and sends (636) the result to the data-gathering utility 614 as part of the HTTP response. The data-gathering utility 614 can thereafter show (638) the results to the user.

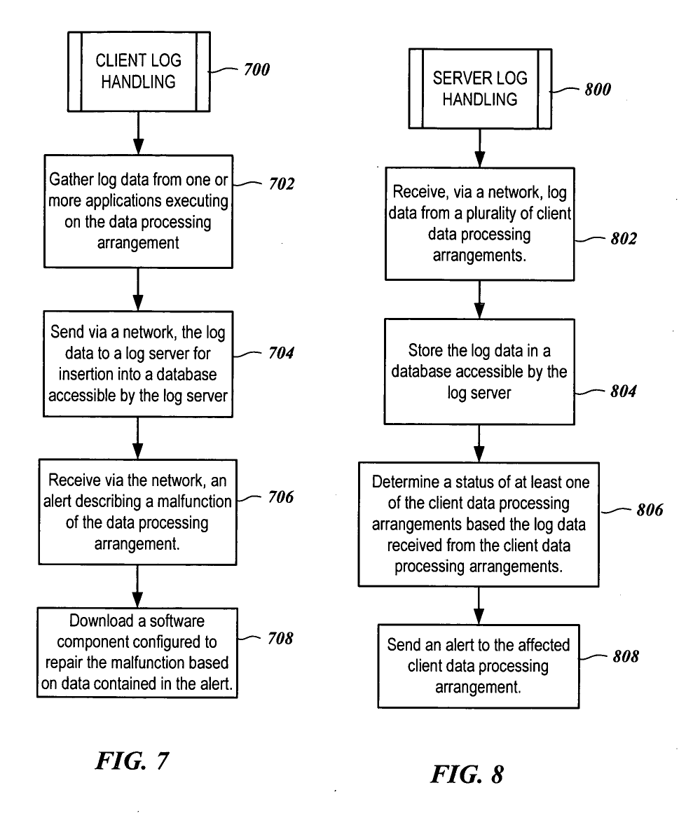

In reference now to FIG. 7, a flowchart illustrates a procedure 700 that may be used by a client data processing arrangement for handling log data according to embodiments of the present invention. A data-gathering utility gathers (702) log data from one or more applications executing on the data processing arrangement. The log data is sent (704) to a log server via a network for insertion into a database accessible by the log server. The client is adapted to receive (706) via the network, an alert describing a malfunction of the data processing arrangement. This alert is generated in response to log data sent to the log server. The client may be directed to download (708) a software component that is configured to repair the malfunction based on data contained in the alert.

In reference now to FIG. 8, a flowchart illustrates a procedure 800 that may be used by a log server for handling log data according to embodiments of the present invention. The log server is configured to receive (802), via a network, log data from a plurality of client data processing arrangements. The log data is stored (804) in a database accessible by the log server.

The log server determines (806) a status of at least one of the client data processing arrangements based the log data received from the client data processing arrangements. For example, the log server may parse data received from the client arrangements and search for identifying data that indicates errors, problems, and/or correct operation. The search may involve specific words, may involve statistical and/or lexical analysis, and may involve comparing the data between various machines to establish non-conforming behavior. The determination (806) may also involve determining that expected data is lacking, such as when a machine or process is hung. Once the log server has determined (806) a change in state of a data processing arrangement, the log server sends (808) an alert to the affected client data processing arrangement based on this determination of status.

Hardware, firmware, software or a combination thereof may be used to perform the various functions and operations described herein of a distributed-computation program. Articles of manufacture encompassing code to carry out functions associated with the present invention are intended to encompass a computer program that exists permanently or temporarily on any computer-usable medium or in any transmitting medium, which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create a distributed-computation system, apparatus, and method in accordance with the present invention.

The foregoing description of the example embodiments of the invention has been presented for the purposes of illustration and description. It is not intended to be exhaustive or to limit the invention to the precise form disclosed. Many modifications and variations are possible in light of the above teaching. It is intended that the scope of the invention not be limited with this detailed description, but rather the scope of the invention is defined by the claims appended hereto.

What is claimed is:

1. A processor-based method for logging data, comprising:
gathering, via a data-gathering utility executing on a first data-processing arrangement, log data from one or more applications executing on the first data-processing arrangement;
sending, via a network, the log data to a Web services interface of a log server;
storing the log data in a database accessible by the log server; and
determining status of the first data processing arrangement based on the log data stored in the database.

2. The method of claim 1, further comprising:
gathering via a plurality of data-gathering applications executing on respective other data processing arrangements, other log data associated with applications running on the respective data processing arrangements; and
storing the other log data in the database via the Web services interface of the log server.

3. The method of claim 2, wherein determining the status of the first data processing arrangement comprises comparing the log data with the other log data received from the other data processing arrangements.

4. The method of claim 1, wherein storing the log data in the database comprises placing the log data in a table of a relational database, wherein the table is indexed by a user ID associated with the first data-processing arrangement.

5. The method of claim 1, wherein storing the log data in the database comprises placing the log data in a table of a relational database, wherein the table is indexed by a transaction ID associated with a transaction performed by at least one of the applications executing on the first data-processing arrangement.

6. The method of claim 1, wherein storing the log data in the database comprises placing the log data in a table of a relational database, wherein the table is indexed by a machine ID associated with the first data-processing arrangement.

7. The method of claim 1, further comprising sending, via the network, an alert to the first data processing arrangement based on determining the status of the first data processing arrangement.

8. The method of claim 7, further comprising downloading a software component to the first data processing arrangement based on data contained in the alert, the software component configured to repair a malfunction indicated by the status.

9. The method of claim 1, further comprising:
sending a query to the Web services interface of the log server; and
retrieving a selected set of the log data from the database based on the query.

10. The method of claim 1, further comprising:
detecting, via the data-gathering utility, the installation of an additional application on the first data processing arrangement; and
gathering, via the data-gathering utility, log data from the additional application based on detection of the additional application.

11. The method of claim 10, wherein detecting the installation of an additional application comprises locating an application registry entry created as a result of the installation of the additional application.

12. The method of claim 1, further comprising:
sending, via the network, a command to the data-gathering utility of the first data processing arrangement; and
changing an amount of data gathered by the data-gathering utility in response to the command.

13. The method of claim 12, wherein changing the amount of data gathered by the data-gathering utility comprises at least one of activating and deactivating logging associated with at least one of the applications of the data processing arrangement.

14. The method of claim 12, wherein changing the amount of data gathered by the data-gathering utility comprises changing a debug level associated at least one of the applications of the data processing arrangement.

15. A processor-based method for handling log data, comprising:
associating a unique identifier associated with a transaction involving two or more data processing arrangements coupled via a network;
gathering log data associated with the transaction via data-gathering utilities executing on each of the data processing arrangements, wherein the log data includes the unique identifier associated with the transaction;
sending, via the network, the log data to a Web services interface of a log server;
storing the log data in a database accessible by the log server;
sending, to the Web services interface of the log server, a query configured to select a set of the log data from the database based on the unique identifier associated with the log data; and
retrieving the selected set of data from the log server.

16. The method of claim 15, further comprising associating the data-gathering utilities with one or more applications executing on the respective data processing arrangements so that the data-gathering utilities receive log data from the one or more applications.

17. The method of claim 16, further comprising:
detecting, via the data-gathering utilities, the installation of additional applications on the data processing arrangements; and
associating the data-gathering utilities with the additional applications of the respective data processing arrangements so that the data-gathering utilities receive log data from the additional applications.

18. The method of claim 15, further comprising:
sending, via the network, a command to a selected data-gathering utility of the data-gathering utilities; and
changing an amount of data gathered by the selected data-gathering utility in response to the command.

19. The method of claim 18, wherein changing the amount of data gathered by the selected data-gathering utility comprises at least one of activating and deactivating logging associated with one or more applications of the associated data processing arrangement.

20. The method of claim 18, wherein changing the rate of data gathering of the selected data-gathering utility comprises changing a debug level associated with one or more applications of the associated data processing arrangement.

21. A processor-readable medium, comprising:
a program storage device configured with instructions for causing a processor of a data processing arrangement to perform the operations of,
gathering log data from one or more applications executing on the data processing arrangement;
sending, via a network, the log data to a log server for insertion into a database accessible by the log server; and
receiving, via the network, an alert describing a malfunction of the data processing arrangement, the malfunction determined based on the log data sent to the log server.

22. The processor-readable medium of claim 21, wherein the operations further comprise downloading a software component to the data processing arrangement based on data contained in the alert, the software component configured to repair the malfunction.

23. The processor-readable medium of claim 21, wherein the operations further comprise:
sending a query to a Web services interface of the log server; and
retrieving a selected set of stored log data from the database based on the query.

24. The processor-readable medium of claim 21, wherein the operations further comprise:
detecting the installation of an additional application on the data processing arrangement; and
gathering log data from the additional application based on detection of the additional application.

25. The processor-readable medium of claim 21, wherein the operations further comprise:
receiving, via the network a command targeted for the data processing arrangement; and
changing a rate of data gathering in response to the command.

26. The processor-readable medium of claim 25, wherein changing the rate of data gathering comprises at least one of activating and deactivating logging associated with at least one of the applications of the data processing arrangement.

27. The processor-readable medium of claim 25, wherein changing the rate of data gathering comprises changing a debug level associated at least one of the applications of the data processing arrangement.

28. A processor-readable medium, comprising:
a program storage device configured with instructions for causing a processor of a data processing arrangement to perform the operations of,
receiving, via a network, log data from a plurality of client data processing arrangements, wherein each client data processing arrangement includes a data-gathering utility that gathers data from applications of the respective client data processing arrangement;
storing the log data in a database accessible by the data processing arrangement;
determining a status of at least one of the client data processing arrangements based the log data received from the client data processing arrangements; and
sending, via the network, an alert to the at least one client data processing arrangement based on determining the status of the at least one client data processing arrangement.

29. The processor-readable medium of claim 28, wherein the operations further comprise providing a downloadable software component to the at least one client data processing arrangement based on data contained in the alert, the software component configured to repair a malfunction indicated by the status of the at least one client data processing arrangement.

30. The processor-readable medium of claim 28, wherein the operations further comprise:
receiving a query at a Web services interface of the data processing arrangement;
retrieving a selected set of the log data from the database based on the query; and
sending the selected set of the log data to an originator of the query.

31. The processor-readable medium of claim 28, wherein the operations further comprise sending, via the network, a command to the data-gathering utility of a selected client data processing arrangement, the command configured to change an amount of data gathered by the data-gathering utility of the selected client data processing arrangement.

32. The processor-readable medium of claim 31, wherein changing the amount of data gathered by the data-gathering utility comprises at least one of activating and deactivating logging associated with at least one application of the selected client data processing arrangement.

33. The processor-readable medium of claim 31, wherein changing the amount of data gathered by the data-gathering utility comprises changing a debug level associated at least application of the selected client data processing arrangement.

34. A system, comprising:
means for gathering log data from one or more applications of a first data-processing arrangement;
means for sending, via a network, the log data to a log server;
means for storing the log data in a database accessible by the log server;
means for comparing the log data with other log data received from additional data processing arrangements; and
means for determining malfunctions of the first data processing arrangement based on the comparison of the log data.
